(19) United States
(12) Patent Application Publication
(10) Pub. No.: US 2026/0201823 A1
(43) Pub. Date: Jul. 16, 2026

(54) METHOD FOR FLUSHING A PRESSURE LINE OF A DELIVERY DEVICE

(71) Applicant: Schaeffler Technologies AG & Co. KG, Herzogenaurach (DE)

(72) Inventors: Cornelius KÖHLER, Hürth (DE); Peter BAUER, Bonn (DE); Tobias LUEBBERT, Köln (DE)

(21) Appl. No.: 19/138,908

(22) PCT Filed: Nov. 30, 2023
(86) PCT No.: PCT/EP2023/083765

§ 371 Date: Jun. 13, 2025

(30) Foreign Application Priority Data
Dec. 16, 2022 (DE) 10 2022 213 813.9

(51) Int. Cl. F01N 3/20

(52) U.S. Cl. CPC F01N 3/2066; F01N 2610/02; F01N 2610/1406; F01N 2610/1433; F01N 2610/1453; F01N 2610/1493

(57) ABSTRACT

A method for operating an aqueous urea solution device having a conveying device withs a pump. (The solution is conveyed from a tank via intake line, through the conveying device to an injector arranged on an exhaust-gas line via a pressure line. A bypass leads to the tank from the pressure. In a first conveying process, the pump is operated in a first conveying direction to convey solution to the injector. After the first conveying process, the injector is closed and the pump is operated in a second conveying direction and the injector is opened for a period of time and air is sucked into the pressure line through the injector into the conveying device. Subsequently, the pump is operated in the first conveying direction while the injector is closed, and air sucked into the conveying device is pushed along the bypass to the tank.

### CROSS REFERENCE TO RELATED APPLICATIONS

This is a U.S. national stage of Application No. PCT/EP2023/083765 filed Nov. 30, 2023. Priority is claimed on German Application No. DE 10 2022 213 813.9 filed Dec. 16, 2022, the contents of which are incorporated herein by reference.

### BACKGROUND OF THE INVENTION

### 1. Field of the Invention

The disclosure relates to a method for operating a device for conveying an aqueous urea solution in a motor vehicle, having a conveying device which has a pump for conveying the aqueous urea solution, wherein the aqueous urea solution is conveyed from a tank via an intake line, through the conveying device and to an injector, arranged outside the conveying device, via a pressure line, wherein the injector is arranged on an exhaust-gas line and is configured for injecting the aqueous urea solution into the exhaust-gas line, wherein a bypass leads to the tank from the pressure line, from a point upstream of the injector, wherein, in a first conveying process, the pump is operated in a first conveying direction in order to convey aqueous urea solution to the injector, wherein, after the first conveying process in the first conveying direction of the pump has ended, the injector is closed and the pump is operated in a second conveying direction, which is opposite to the first conveying direction, in a second conveying process, wherein the injector is opened for a predetermined period of time T1 and air is sucked into the pressure line through the injector. The invention moreover relates to a device for carrying out the method.

### 2. Description of the Related Art

Worldwide, many countries have set legal regulations which define an upper limit value for the content of certain substances in the exhaust gas of internal combustion engines. This relates for the most part to substances whose discharge to the atmosphere is undesirable. One of said substances is nitrogen oxides (NOx), whose proportion in the exhaust gas must not exceed legally defined limit values. On account of the boundary conditions, for example the design of internal combustion engines for favorable fuel consumption or the like, the engine-internal prevention of nitrogen-oxide emissions is suitable only to a limited extent for the reduction of the proportion of nitrogen oxides in the exhaust gas, so that exhaust-gas aftertreatment is necessary for adhering to relatively low limit values.

Here, it has been proven that a selective catalytic reduction (SCR) of the nitrogen oxides is advantageous. Said SCR method requires a reducing agent which contains nitrogen. The use of ammonia (NH3) as a reducing agent has in particular proven to be one possible alternative. On account of the chemical properties and the legal provisions in many countries, the ammonia is usually not kept as pure ammonia, since this can lead to problems in particular in motor vehicles or other mobile applications. Rather, instead of the reducing agent itself being stored, reducing-agent precursors are often stored and carried along. A reducing-agent precursor is to be understood as meaning in particular a substance which releases the reducing agent or which can be converted chemically into the reducing agent. For example, urea constitutes a reducing-agent precursor for the reducing agent ammonia.

The aqueous ammonia solution, the urea, is carried along in a tank and conveyed into the exhaust-gas line in accurately metered amounts by a suitable conveying device. The conveying device generally has for this purpose inter alia a pump for conveying the fluid, one or more filters for cleaning the fluid, possibly heating devices for thawing the fluid, and a control device for processing internal and external data and for controlling the pump, the heating devices and further controllable components, such as for example one or more injectors.

The conveying devices used for conveying the aqueous ammonia solution, and in particular the injectors, must be designed in such a way that freezing of the aqueous ammonia solution is prevented, so as to prevent damage, in particular to the injectors. Therefore, use is made of procedures in which the aqueous urea solution is removed from the injectors after the conveying device has been deactivated. In said procedures, it must at the same time be ensured that the components of the conveying device remain subjected to aqueous ammonia solution so as to prevent crystallization of the aqueous ammonia solution at these components. For this purpose, a flushing process in which the conveying pump is operated in the opposite direction while the injectors are in a closed state is carried out. The injectors are finally opened for a defined period of time, whereby air is sucked to the conveying device through the injectors and the aqueous ammonia solution is sucked from the lines and the injectors.

A disadvantage of the solutions from the prior art is in particular that it is very difficult to scale the generated negative pressure and the return flow generated by the negative pressure in such a way that the injectors and the lines leading to the injectors are indeed emptied, but the remaining components of the conveying device are not emptied. The result of this is that, generally, rather small negative pressures are built up, and thus the return flow is also small. This can result in residues of the aqueous ammonia solution remaining behind in the injectors or lines and forming deposits there.

If the scaling for the negative pressure, and thus for the return flow, is too great, it can result in air being sucked into the conveying device and crystallization consequently occurring at the pump, filter or other components of the conveying device. This is also due in particular to the fact that all the installed components have certain component tolerances, whereby the actual conveying power of the pump varies unpredictably from pump to pump and thus an unknown amount of aqueous ammonia solution is sucked in. The unpredictability in the amount of aqueous ammonia solution sucked in results in a flushing process that is unreliable and that cannot reliably prevent damage to the injectors or to the conveying device.

### SUMMARY OF THE INVENTION

The problem addressed by one aspect of the present invention is therefore that of providing a method for operating a device for exhaust-gas aftertreatment that ensures a reliable flushing process for the lines to the injectors and for the injectors themselves, so as to prevent damage to the injectors and to the conveying device itself. The problem addressed by the present invention is moreover that of providing a device.

An exemplary aspect of the invention relates to a method for operating a device for conveying an aqueous urea solution in a motor vehicle, having a conveying device which has a pump for conveying the aqueous urea solution, wherein the aqueous urea solution is conveyed from a tank via an intake line, through the conveying device and to an injector, arranged outside the conveying device, via a pressure line, wherein the injector is arranged on an exhaust-gas line and is configured for injecting the aqueous urea solution into the exhaust-gas line, wherein a bypass leads to the tank from the pressure line, from a point upstream of the injector, wherein, in a first conveying process, the pump is operated in a first conveying direction in order to convey aqueous urea solution to the injector, wherein, after the first conveying process in the first conveying direction of the pump has ended, the injector is closed and the pump is operated in a second conveying direction, which is opposite to the first conveying direction, in a second conveying process, wherein the injector is opened for a predetermined period of time T1 and air is sucked into the pressure line through the injector, wherein the air sucked through the injector is sucked into the conveying device, wherein subsequently, in a third conveying process, the pump is operated again in the first conveying direction while the injector is closed, wherein the air sucked into the conveying device is pushed along the bypass to the tank.

The aim of the method is in particular to generate during the second conveying process a negative pressure in the pressure line and parts of the conveyor device that is significantly higher when considered relatively with respect to the method known from the prior art. This results in the aqueous urea solution situated in the pressure line being sucked back into the conveying device significantly further than otherwise when the injector or injectors are opened. This ensures that aqueous urea solution is no longer present at the injectors and preferably also in the complete pressure line, and that in particular no deposits occur in the pressure line.

Through the provision of a third conveying process, in which the pump again conveys aqueous urea solution from the tank in the direction of the pressure line or in the direction of the injector or the injectors, the air situated in the conveying device is pumped through the bypass branching off from the pressure line and into the tank, where the air can be extracted from the system by a tank vent. Since the injector or injectors is/are completely closed during the third conveying process, the air is preferably conveyed along the bypass. Since that portion of the pressure line which is situated downstream of the branch of the bypass and upstream of the injector or the injectors is also filled with air before the third conveying process, this air is displaced in the direction of the closed injector or injectors by the aqueous urea solution subsequently conveyed during the third conveying process and, there, is compressed by the intrinsically incompressible aqueous urea solution. With this compressed air volume, it can be ensured that the injector or injectors are not subjected to aqueous urea solution after completion of the third conveying process.

After the third conveying process has ended, the air compressed in front of the injector or injectors expands again slightly since the compressing conveying pressure of the pump is removed. This increases the air-filled line length of the pressure line.

It is particularly advantageous if a proportion of air remaining in the pressure line remains at that portion of the pressure line which ends in the injector. This ensures that the injector or injectors are not subjected to the aqueous urea solution when the device is not in operation. This ensures that the injector or injectors are not damaged.

It is also advantageous if the air remaining in the pressure line at the injector expands in the pressure line after the pump has been deactivated, wherein the amount of air is small enough that no air passes into the conveying device via the pressure line. This furthermore ensures that no aqueous urea solution remains at the injector or injectors. Moreover, a situation in which, as a result of the expansion of the air volume remaining in the pressure line, air again passes into the conveying device and thereby possibly into the pump, the filter or other components, which are preferably subjected completely to the aqueous urea solution outside of operation, is prevented.

One preferred exemplary embodiment is characterized in that the pressure built up during the third conveying process is low enough to rule out conveyance of aqueous urea solution to the injector. This is intended to prevent aqueous urea solution from being conveyed to the injector or injectors after all.

It is also preferable if provision is made of two injectors which are connected fluidically in parallel with one another and are arranged in the pressure line downstream of the bypass.

Moreover, it is advantageous if the negative pressure, generated by the pump, during the second conveying process is selected in such a way that the entire aqueous urea solution present in the pressure line is sucked back into the conveying device. This is advantageous for ensuring that the pressure line is completely empty, no aqueous urea solution remains at the injector or injectors, and also no deposits and residues of the aqueous urea solution remain in the pressure line.

It is furthermore advantageous if, during the third conveying process, the air situated in the conveying device and the pressure line is pushed into the tank via the bypass, wherein a proportion of the air remains in front of the closed injectors in a compressed state, wherein the air forms a cushion between the aqueous urea solution and the injectors. The air pushed into the tank can be easily removed from the tank via a tank vent, as is known from the prior art. The fact that the injector or injectors is/are completely closed during the third conveying process means that the air situated directly in front of the injector or injectors before the third conveying process has no possibility of escaping. Said air, as a compressible medium, is compressed by the incompressible aqueous urea solution in front of the closed injector or closed injectors.

An exemplary aspect of the invention relates to a device for conveying an aqueous urea solution in a motor vehicle, wherein the device comprises a conveying device which is configured to convey the aqueous urea solution from a tank to at least one injector which is arranged outside the conveying device, wherein the at least one injector is configured to inject the aqueous urea solution into an exhaust-gas line, wherein the conveying device has a pump which is configured to suck the aqueous urea solution from the tank along an intake line, and to convey this to the injector along a pressure line, wherein a bypass runs to the tank from the pressure line upstream of the injector, wherein the pump is configured to be operated in a first conveying direction and in a second conveying direction, which is opposite to the first conveying direction.

Such an invention can be advantageously operated by the method described above.

It is also expedient if, outside the conveying device, provision is made of two injectors which are arranged fludically in parallel and which are attached to the pressure line downstream of the branch of the bypass.

Advantageous refinements of the present invention are described in the dependent claims and in the description of the figures that follows.

### BRIEF DESCRIPTION OF THE DRAWINGS

The invention will be discussed in detail below on the basis of an exemplary embodiment and with reference to the drawing. In the drawing:

FIGS. 1A-1C show a schematic illustration of a device.

### DETAILED DESCRIPTION OF THE PRESENTLY PREFERRED EMBODIMENTS

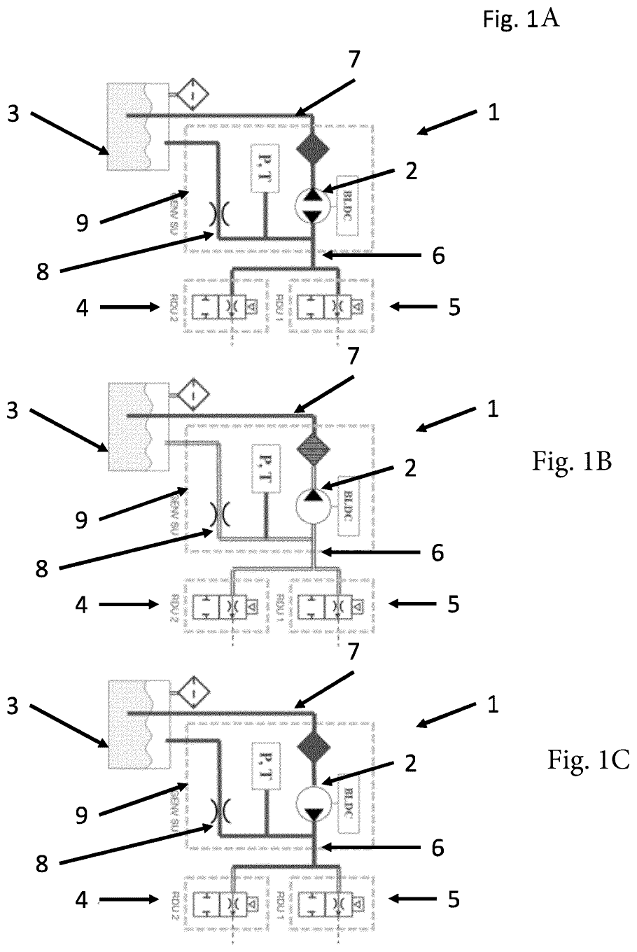

FIGS. 1A-1C show three representations of a device 1, wherein the three representations show different operating states of the device 1.

The representation in FIG. 1A shows the state of the device 1 in which the pump 2 has ended its regular operation, during which it conveys the aqueous urea solution from the tank 3 to the two injectors 4, 5 along the pressure line 6. It can be seen that the intake line 7 from the tank 3 to the pump 2, the bypass 8, which runs from the pressure line 6 to the tank 3, and the pressure line 6 to the injectors 4, 5 are filled completely with the aqueous urea solution.

The actual conveying device 9 consists in particular of the pump 2, the bypass 8 and possibly a filter for the aqueous urea solution. The conveying device is preferably arranged in a separate housing, which has connections for the suction line from the tank 3 and for the pressure line 6, which adjoins the conveying device.

The representation in FIG. 1B illustrates the second conveying process. The pump 2 is operated counter to the conveying direction of normal conveying operation, so that the aqueous urea solution is conveyed from the injectors 4, 5 to the tank 3 along the pressure line 6. Since the injectors 4, 5 are open in this case, the return conveyance results in a negative pressure being generated in the pressure line 6 and air being conveyed through the open injectors 4, 5 into the pressure line 6 and finally into the pump 2 and the bypass 8 and, at the same time, the aqueous urea solution situated there beforehand being displaced in the direction of the tank 3. At the end of the second conveying process, the injectors 4, 5 are closed and the pump 2 is deactivated.

The representation in FIG. 1C shows the third conveying process, which follows the second conveying process. In this conveying process, with the injectors 4, 5 still closed, the pump 2 is again operated in the conveying direction 9 intended for regular conveying operation. Consequently, aqueous urea solution is again conveyed from tank 3 into the pressure line 6. The bypass 8, too, which is connected fluidically to the tank 3, is filled with aqueous urea solution by way of the third conveying process.

As can be seen in FIG. 1C, a certain proportion of air remains directly in front of the closed injectors 4, 5 and, there, is compressed by the subsequently conveyed aqueous urea solution. In this way, it is ensured that the injectors 4, 5 are not in direct contact with the aqueous urea solution and at the same time the conveying device 9 is, or the individual components of the conveying device 9 are, subjected completely to aqueous urea solution.

After the third conveying process has ended, the air in front of the injectors 4, 5 previously compressed by the aqueous urea solution expands and displaces the aqueous urea solution slightly back into the pressure line 6.

The state shown in FIG. 1C illustrates the end state of the device 1 after normal operation has ended. In this state, the injectors 4, 5 are protected against freezing and the conveying device 9 is subjected completely to the aqueous urea solution, so that, at the com-ponents thereof, crystallization, which could lead to the components being damaged, cannot occur.

The exemplary embodiment of FIGS. 1A-1C is in particular not of a limiting nature and serves for illustrating the concept of the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A method for operating a device configured to convey an aqueous urea solution in a motor vehicle, having a conveying device which has a pump for conveying the aqueous urea solution, comprising:
in a first conveying process:
operating the pump in a first conveying direction to convey aqueous urea solution to at least one injector; and
conveying the aqueous urea solution from a tank via an intake line, through the conveying device, to the at least one injector, arranged outside the conveying device, via a pressure line, wherein the at least one injector is arranged on an exhaust-gas line and is configured to inject the aqueous urea solution into the exhaust-gas line, wherein a bypass leads to the tank from the pressure line, from a point upstream of the at least one injector;
in a second conveying process, after the first conveying process has ended:
closing the at least one injector; and
operating the pump in a second conveying direction, which is opposite to the first conveying direction, opening the at least one injector for a predetermined period of time;
drawing air into the pressure line through the at least one injector, wherein the air drawn through the at least one injector is drawn into the conveying device; and
in a third conveying process:
operating the pump in the first conveying direction while the at least one injector is closed, wherein the air drawn into the conveying device is pushed along the bypass to the tank.

11. The method as claimed in claim 10, wherein a proportion of air remaining in the pressure line remains at that portion of the pressure line which ends in the at least one injector.

12. The method as claimed in claim 11,
wherein an amount of air remaining in the pressure line at the at least one injector expands in the pressure line after the pump has been deactivated, and
wherein the amount of air is small enough that no air passes into the conveying device via the pressure line.

13. The method as claimed in claim 10, wherein a pressure built up during the third conveying process is low enough to rule out conveyance of aqueous urea solution to the at least one injector.

14. The method as claimed in claim 10, wherein provision is made for two injectors which are connected fluidically in parallel with one another and are arranged in the pressure line downstream of the bypass.

15. The method as claimed in claim 10, wherein a negative pressure, generated by the pump, during the second conveying process is selected such that an entire aqueous urea solution present in the pressure line is drawn back into the conveying device.

16. The method as claimed in claim 10, wherein, during the third conveying process, the air situated in the conveying device and the pressure line is pushed into the tank via the bypass, wherein a proportion of the air remains in front of the closed injector in a compressed state, wherein the air forms a cushion between the aqueous urea solution and the at least one injector.

17. A device configured to convey an aqueous urea solution in a motor vehicle, comprising:
a conveying device which is configured to convey the aqueous urea solution from a tank to at least one injector which is arranged outside the conveying device, wherein the at least one injector is configured to inject the aqueous urea solution into an exhaust-gas line, wherein the conveying device comprises:
a pump which is configured to draw the aqueous urea solution from the tank along an intake line, and to convey this to the at least one injector along a pressure line, wherein a bypass runs to the tank from the pressure line upstream of the at least one injector,
wherein the pump is configured to be operated in a first conveying direction and in a second conveying direction, which is opposite to the first conveying direction.

18. The device as claimed in claim 17, wherein, outside the conveying device, provision is made for two injectors which are arranged fludically in parallel and which are attached to the pressure line downstream of a branch of the bypass.
